(19) United States
(12) Patent Application Publication
(10) Pub. No.: US 2022/0330390 A1
(43) Pub. Date: Oct. 13, 2022

(54) MULTI-DIMENSION HEATED PACKAGES AND VESSELS

(71) Applicant: Inductive Intelligence, LLC, Fennville, MI (US)

(72) Inventors: David W Baarman, Fennville, MI (US); Gregory L. Clark, Ada, MI (US); Benjamin C. Moes, Wyoming, MI (US)

(21) Appl. No.: 17/621,037

(22) PCT Filed: Jun. 19, 2020
(86) PCT No.: PCT/US2020/038628

§ 371 Date: Dec. 20, 2021

Related U.S. Application Data
(60) Provisional application No. 62/864,525, filed on Jun. 21, 2019.

(51) Int. Cl. H05B 6/10; H02J 50/10; A47J 47/14; A47J 36/24; A47J 27/00

(52) U.S. Cl. CPC H05B 6/105; H02J 50/10; A47J 47/14; A47J 36/2488; A47J 27/004

(57) ABSTRACT

A system and method for integrating inductive heating into packaging and other product vessels that allows for controlled heat distribution. The system and method provides for multidimensional heating of a packaged item on multiple sides at the same time using electromagnetic energy emitted from a single source. The inductively heated package may include a heating element having a plurality of conductive elements configured to implement a desired heating profile. The conductive elements may be arranged in layers to allow heating on different surfaces of a packaged item. Each layer of the heating element may be configured to distribute the available energy as needed for an ultimate cooking experience. The present invention provides a method of design where the sum of the available energy is distributed in accordance with the desired heating profile. The heating method enables boxes, vessels, wrappers, pouches, bags, and other containers

### FIELD OF THE INVENTION

The present invention relates to heated product packaging and vessels, and more particularly, to product packaging and product vessels that are heated wirelessly through the use of electromagnetic fields.

### BACKGROUND OF THE INVENTION

Inductive heating system are used to provide wireless heating of surfaces. Past solutions range from pans used in induction cooking applications to packages that have metal surfaces for heating packaged items. In conventional inductively heated packages, a continuous sheet or segment of conductive material is disposed in the package. Although it is possible that in some applications portions of the conductive material to extend along different sides of the package, the portion of the continuous sheet closest to the electromagnetic transmitter receives most (if not all) of the power available in the electromagnetic field. It should be noted that the energy used and the heating surface restricts the distribution of energy to the thermodynamics of that complete surface and the material used as the electromagnetic field is mostly consumed. Although this is helpful for general heating and cooking it has limitations in the context of packaging and particularly with respect to potential targeted heat distribution.

Inductively heated packaging is currently in limited commercial use. Conventional inductively heated packaging systems are used to heat a variety of foods and beverages while they remain in the package. A typical inductive heating system includes an inductive power supply capable of generating an inductive or electromagnetic field over a power transfer surface and an inductively heated package that can be placed on the power transfer surface and includes a heating element that heats in the presence of the magnetic field. For example, individual serving sizes of foods, such as soups and sandwiches, and beverages, such as coffee and hot chocolate, are available in inductively heated packaging that allow the food or beverage to be heated while it remains in its packaging.

Conventional inductive heating and cooking systems typically incorporate foils or plates that absorb induction energy and convert it directly to heat. These foils and plates heat only in the areas that receive the induction energy, and then only in proportion to the amount of inductive energy received. Given that the energy available from the magnetic field varies over space not only with the inherent shape and magnitude of the magnetic field, but also based on the presence of conductive/reflective/absorbent materials present in the field, it can be difficult to reliably produce complex heating profiles using conventional inductive heating and cooking systems and methods. This difficulty is dramatically increased when it is desirable to generate a multi-dimensional heating profile.

There is an unmet need to enable a more reliable solution with a more positive outcome. Past solutions are not designed for ease of interaction and typically are not designed for intelligent control. By controlling the location, duration and intensity of heat within an inductive system we can provide a more controlled heating solution for better customer satisfaction.

### SUMMARY OF THE INVENTION

The present invention provides an inductively heated package or vessel having a heating element configured to generate and distribute heat in accordance with a desired heating profile. The heating element is configured to interact with the magnetic field to produce controlled heating through various regions of the package or vessel. The heating element may be used, for example, to provide three-dimensional heating of the contents of a package or vessel or to provide heating even in regions of the package or vessel located outside the magnetic field in regions where the magnetic field is not sufficient to directly generate the desired heat.

In one embodiment, the heating element includes conductive elements that are configured to produce the desired heating profile. For example, a heating element may include a non-uniform arrangement of conductive elements that are selected to provide the desired heating profile taking into consideration the properties of the magnetic field. The amount of conductive material may be increased in regions where additional heating is desired or to compensate in regions where the magnetic field is weaker. For example, the width and/or thickness of the conductive material may be increased in a region to increase the generation of heat in that region and the width and/or thickness of the conductive material be decreased in a region to decrease the generation of heat. By selectively designing where heat will be delivered, a package can be configured to more efficiently cook, bake, brown and crisp different foods by understanding the thermodynamic load and applying energy in these areas more directly. As an example, in the context of a cookie where the center may need more energy, the heated package can be configured to provide concentrated heat at the center while browning the top and crisping the bottom to provide a user designed experience. The present invention allows a programmed energy delivery (e.g. thermal energy delivery) for the specific thermodynamic mix, or food that delivers energy in the x, y and Z axis as designed by selectively concentrating the conductive elements to essentially program the package to deliver the energy required for the desired heating profile.

In one embodiment, the heating element has a three-dimensional shape allowing heat to be produced in three-dimensions. For example, the heating element may extend over two layers on opposite sides of the packaged item, such as the top and bottom surfaces of a packaged food item. In this context, the heating element may be configured to provide the desired heating profile on both sides of the packaged item taking into consideration the properties of the magnetic field and the affect that the different layers of the heating element will have on the magnetic field.

In one embodiment, a three-dimensional heating element is configured with at least two layers of conductive elements that cooperatively produce the desired heating profile. In this context, the design and configuration of the conductive elements in the first layer (i.e. the layer closest to the inductive power supply) may be selected to control the amount of inductive energy that passes through the first layer to the conductive elements in the second layer (i.e. the layer farther away from the inductive power supply). It should be noted that metalized areas that are thin enough will allow wireless energy to pass while still enabling the metalized layer for food safety.

In one embodiment, the conductive elements in the first layer of the heating element are configured to provide gaps that allow the desired portions of the magnetic field to reach the conductive elements in the second layer. For example, the conductive elements in the first layer may be spaced apart to provide gaps and the conductive elements in the second layer may extend along the gaps to intercept the magnetic field passing through those gaps. As another example, the conductive elements in the first layer and the second layer may be aligned, but the conductive elements in the first layer may be narrower than the conductive elements in the second layer. These embodiments allow the second layer to intercept portions of the magnetic field passing through the first layer.

In one embodiment, the conductive element may be configured to generate loop currents that result in resistive heating. In one embodiment, the design and configuration of the heating element is predetermined to combine resistive heating and eddy-current heating to generate the desired heating profile from the expected electromagnetic field. The heating element may include at least one conductive element that is in the shape of a loop that generates loop current within the heating element in response to the electromagnetic field.

In one embodiment, the loop current may be used to move electrical energy within the heating element to allow the selective production of resistive heating in accordance with the desired heating profile. In some embodiments, the loop current may be used to generate resistive heating in portions of the package where the magnetic field is not inherently sufficient to produce the desired level of heat using eddy current heating. For example, a conductive element may be arranged in the form of a loop where at least a portion of the loop is located in a position where more energy is present in the magnetic field than needed to locally generate the desired level of heating and at least a portion of the loop is located in a position where there is not sufficient energy in the magnetic field to generate the desired level of heating. In this example, the conductive loop can be used to transfer energy from the region of excess magnetic field to the region of insufficient magnetic field.

In one embodiment, a three-dimensional heating element is configured to produce the desired heating profile by varying the arrangement of conductive elements and/or to produce loop currents that transfer electrical energy to other portions of the heating element where resistive heating is desired.

In one embodiment, the loop current is used to generate a secondary magnetic field to relay power to an isolated heating element. The isolated heating element may be in the same package or vessel, or it may be in a separate package or vessel. A series of packages or vessels with heating elements that establish loop current of this type can be used to produce a chain that feeds power in sequence from one package or vessel to the next.

The present invention provides inductively heated packaging capable of addressing a variety of conventional problems, including without limitation, the following:

1. Distributed electromagnetic energy: The need to share energy on multiple surfaces to more evenly heat an object creates a more efficient way to cook or heat. For example, the ability to harvest energy at will by the way the package and the heating element is designed allows a cookie to be baked evenly.

2. Package types: This solution allows inductively heated wrappers, bags, boxes, vessels, (like a small pizza over or cookie oven). The simplicity of cooking in the package allows enhanced preparation and storage options.

3. Varying thickness, shape and current carrying elements: Conventional inductively heated packages use a heating element with even metallic or conductive properties. Heating elements in accordance with the present invention can change surface area and thickness to have varied power distribution for specific reasons.

4. Distributed heat for varied experiences: Some of the objectives that might exist for heated packaging include browning, center heating, rapid heating and crisping. Conventional technologies have been able to do this reasonably well on one surface of the packaged item. Heating elements in accordance with the present invention can produce a heating profile that addresses multiple surfaces of the package item. These surfaces can be designed to change over time as well. In some applications, the conductive materials used to form the heating element may have conductive properties that vary with temperature. For example, all or a portion of the conductive elements that form the heating element can be designed to melt or otherwise change characteristics at a specific temperature, thereby changing the conductive properties. Varying the conductive properties of all or a portion of the heating element can be used to provide a heating profile that varies over time. To illustrate, time-varying conductive elements can be used to shift the focus of heat over time from one region to another to, for example, first heat the outer edges of a cookie and then focus heat on the interior. As another illustration, in heating elements with two layers, the first layer (e.g. the layer closest to source of electromagnetic field) may be manufactured from a material that undergoes a reduction in conductivity at higher temperatures. This allows heating to be sequenced beginning with heat generation focused at the first layer until the transition temperature is reached and then with the heat generation focused at the second layer, for example, first heating the bottom of a pizza (e.g. crisping the crust) and then heating the top (e.g. melting the cheese).

5. Smart multidimensional package: The use of a temperature tracking tag and the multidimensional package along with recorded temperature data for the distribution of heat enables tracking the temperature of the package top and bottom. This information may be used in realtime by the inductive power supply to control the amount of energy provided to the package. For example, the inductive power supply may increase the magnitude of the magnetic field if the temperature tracking data reveals that the temperature is lower than desired, decrease the magnetic field if the temperature is too high or maintain the present magnitude when the temperature is within the desired range.

6. Baking or grill marks: Heating elements in accordance with the present invention can allow heat to be concentrated in the form of grill marks on food. The current pathways can be designed to evenly distributed heat across the pathways and heat the target food.

7. Patterns and energy usage: The present invention can be used to generate a wide range of heating profiles that focus heat on different regions of the packaged item. For example, the heating element may focus more heat on the interior of a cookie as the interior has more mass that the outer area. The distribution of power in multiple dimensions becomes very valuable for optimized cooking and an optimized experience that can be designed. The pattern can be varied by mass to match power with heating mass.

8. Heating and power together: Heating elements in accordance with the present invention may include layers (or regions) of conductive elements designed on the lower level(s) (or in certain regions) to deliver the power needed for heating while at other level(s) (or in other regions) additional power can be harvested for additional purposes. For example, in the example of a candle with a wax body and an LED flame that can be powered inductively by an integrated receiver coil, the package may include a heating element that heats the wax on the base of the candle and a conductive loop that generates a supplemental electromagnetic field to induce power in the receiver coil integrated into the candle. In alternative embodiments, the heating element may receive only a portion of the electromagnetic field and the remaining electromagnetic field may power a receiver coil in the packaged product. For example, returning to the context of a candle with an inductively powered LED flame, a portion of the electromagnetic field may be consumed by the heating element in the package to heat the wax base and a portion of the electromagnetic field may be directly consumed by the receiver coil in the candle to power the LED flame.

9. Package as a heating element: The present invention allows an inductively heated package to produce essentially any desired heating profile by carefully designing the pattern and the resistance of the conductive elements in the heating element.

In one alternative embodiment, the present invention provides a method for designing and manufacturing an inductively heated package or other vessel in accordance with the principles disclosed herein. The method including the steps of designing a heating element to implement a desired heating profile when placed in an expected magnetic field. The heating element having a plurality of conductive elements configured to generate eddy currents and/or loop currents that cause the heating element to heat in accordance with the desired heating profile. The number, size, shape, pattern, arrangement, mass, thickness, width, material type and other properties of the conductive elements may be designed to generate the desired heating profile when engaged by the expected electromagnetic field. For example, the heating element may be designed with conductive elements arranged in layers, the conductive elements may define at least one aperture to facilitate the passage of field from one layer to the next, the conductive elements may define at least one conductive loop to help produce loop currents, the conductive elements may be designed to heat in response to a combination of induced eddy currents and induced loop currents.

In another alternative embodiment, the present invention provides a method for heating a product in an inductively heated package or other vessel by providing an inductively heated package/vessel configured in accordance with the principles disclosure herein, packaging or otherwise situating the product in the package/vessel and applying a magnetic field to the inductively heated package/vessel to heat the product in accordance with the heating profile designed into the inductively heated package.

The present invention can be used to provide several key solutions to past problems that have been observed and modified for better results in the production environment. The heating system is designed to target heat distribution to specific areas as it relates to heating mass. Heating in this way is not limited to the thermodynamics of a homogenous cooking surface but can be tailored to heat more directly is areas that will absorb heat at a higher rate. The ability to design these surfaces and distribute heat over multiple dimensions in a package enables more efficient heating while also enabling an additional level of tuning to the process of heating, crisping, browning and internal temperatures. Taking frozen foods and cooking them in package poses a challenge when the item being heated is not a liquid. For liquids, heat is transferred through the material relatively evenly even when a heating element is located only on one side of a package or in one area. For frozen foods that are solid such as breads or crusts, meats, or other food items, heat must often be applied to multiple sides or areas of the food item. While some embodiments of induction heating and cooking use foils or plates that absorb induction energy and convert it directly to heat, these foils and plates heat only in the areas that receive the induction energy. The presented embodiments provide a means to heat multiple areas of a product within an enclosed package.

These and other features of the invention will be more fully understood and appreciated by reference to the description of the embodiments and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. In addition, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z ; and Y, Z.

### BRIEF DESCRIPTION OF THE DRAWINGS

The invention is described in detail below with reference to the accompanying figures in which:

FIG. 1 illustrates a representational illustration of an inductive heating system showing an inductively heated package positioned on the inductive power transfer surface of an inductive power supply.

FIG. 2 illustrates a top view of a blank for a pizza box including a heating element in accordance with an embodiment of the present invention.

FIG. 2a shows the top view of FIG. 2 with currents that are induced within the material from the magnetic field and loop currents formed as a result of the conductive elements being arranged in the form of a loop or coil.

FIG. 3 shows a box blank having a heating element with an additional pattern of conductive elements to concentrate power toward the center of a particular surface.

FIG. 4 shows the folded configuration of a package, such as pizza box, and a heating element within the box.

FIG. 5 shows the heating element printed on a sheet or other flat stock of material that might be used to form a pouch, sandwich wrapper, bag or other type of packaging.

FIG. 6 shows a heating element having separate top and bottom heating elements portions that can be disposed in the top and bottom halves of a package.

FIG. 7 shows a heating element and an electronic assembly.

FIG. 8 shows the construction of a heating element where two loops receive inductive energy and are connected to allow current to flow through both loops.

FIG. 9 shows the heating element of FIG. 8 integrated into a folded paperboard package.

FIG. 10 shows an embodiment where a heating element has an inner coil loop and an outer coil loop that is used to heat a large surface area.

FIG. 11 shows an embodiment of an inductive receiver.

FIG. 12 shows an embodiment of a heating element in the shape of a coil or loop where the conductive elements are wider at the folding areas.

FIG. 13 shows an example of a heating profile over time of a frozen product.

FIG. 14 shows an embodiment of a heating element where a material with low thermal resistance is placed behind a portion of the coil to provide more even heat distribution within the package.

FIG. 15 shows the another view of the package of FIG. 14.

FIG. 16 shows a representation of a transmitter coil of an inductive power supply disposed toward one end of a stack of inductively heated packages.

FIG. 17 shows several packages stacked such that an edge portion of each package is aligned with a transmitting coil of an inductive power supply such that energy can be delivered to each package simultaneously.

FIG. 18 shows an embodiment where a coil antenna is connected to both an NFC tag and a heating element.

FIG. 19 shows an equivalent circuit for the FIG. 18 embodiment at the heating frequency where the heating element acts as a resistance.

FIG. 20 shows an equivalent circuit for the FIG. 18 embodiment at the NFC frequency wherein the construction of the heating element includes back-and-forth traces that cause significantly higher resistance as well as inductance.

FIG. 21 shows a multidimensional inductively heated vessel (or cooking device) that includes an insulated cover and internal ceramic layers.

FIG. 22 shows an alternative embodiment of a multidimensional inductively heated package where top and bottom portions have strips of metallic material applied to the inside of the container.

FIG. 23 shows a multidimensional package wherein the conducting elements are varied in width between the top of the package and bottom of the package to absorb different amounts of the magnetic field.

FIG. 24 shows an alternative embodiment of the inductively heated package of FIG. 23.

FIG. 25 shows an alternative embodiment intended for use in applications where the transmitting coil of the inductive power supply are smaller than the desired heating area.

### DESCRIPTION OF THE CURRENT EMBODIMENTS

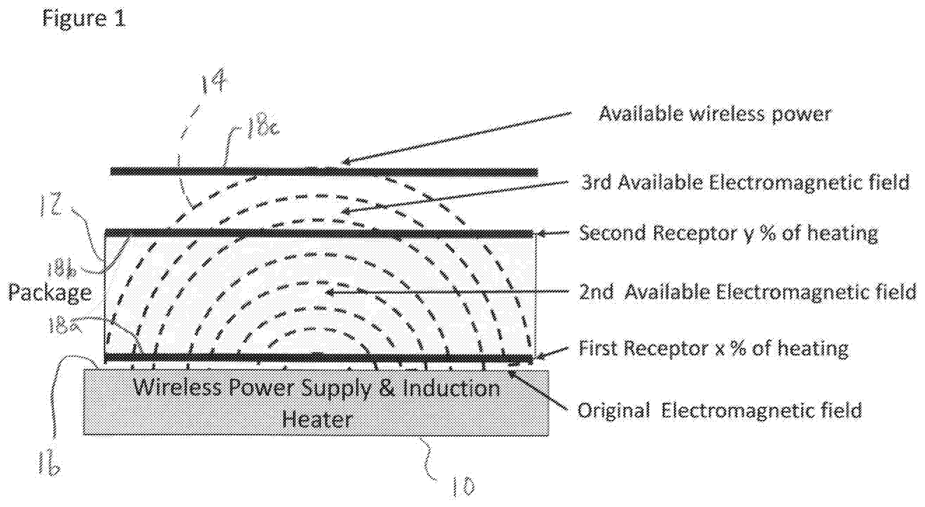

The present invention relates to inductively heated packages and other vessels configured to generate and distribute heat in accordance with a desired multi-dimensional heating profile. FIGS. 1-25 show various alternative embodiments of the present invention. In the various illustrated embodiments, the package or vessel includes a heating element configured to interact with a magnetic field to produce controlled heating through various regions of the package or vessel. The heating element may be used, for example, to provide three-dimensional heating of the contents of a package or vessel or to provide heating even in regions of the package or vessel located outside the magnetic field in regions where the magnetic field is not sufficient to directly generate the desired heat.

Packages and other vessels incorporating embodiments of the present invention may be used to contain food, beverages and other items that might benefit from heating. For example, the present invention may be incorporated into point of sale packaging for food or other consumable items that are to be heated before consumption. As another example, the present invention may be incorporated into take-out and delivery packaging for food items, such as pizza delivery boxes or take-out container used to cook, heat or maintain the warmth of consumables. In still other applications, the present invention may be incorporated into packages for non-consumable items that might otherwise benefit from heating, such as packaging for heating pads and for topical treatments, such as lotions, cosmetics and other similar items.

In an embodiment shown in FIG. 1, the present invention may include an inductive power supply 10 and an inductively heated package 12. In this embodiment, the inductive power supply 10 is configured to produce a magnetic field, such as electromagnetic field 14, over a power transfer surface 16. The inductively heated package 12 is configured to rest upon the power transfer surface 16 and includes an inductive heating element 18 that is situated at least partially within the magnetic field 12. The inductive power supply 10 may be essentially any inductive power supply capable of producing an appropriate magnetic field. For example, the inductive power supply 10 may be an inductive power supply that is compatible with the Qi wireless power standard, which is incorporated herein in its entirety. The inductive power supply 10 may additionally or alternatively be compatible with other wireless power standards. In some applications, the inductive power supply 10 may be a proprietary system and may not be compatible with any current wireless power standard. However, compliance with an existing wireless power standard may facilitate adoption and may allow the inductive power supply to provide the supplemental function of wirelessly supplying power to compatible portable electronic devices.

FIG. 1 is a representational illustration of an inductive heating system showing an inductively heated package 12 positioned on the inductive power transfer surface 16 of an inductive power supply 10. In this illustration, the system 10 is configured to generate heat in multi dimensions and showing the power availability through multiple layers. In this embodiment, the package 12 includes a heating element 18 with a plurality of layers 18a and 18b. In this embodiment, each layers 18a and 18b includes an arrangement of conductive elements 20 specially configured to absorb the desired level of energy from the magnetic field 12 and to allow the remaining magnetic field reach the second layer 18b and the third layer 18c. In this embodiment, the third layer 18c is disposed outside the package 12 and may, for example, be a heating element in a separate package place atop the package 12. As described in more detail below, each layer 18a and layer 18b can be designed to use only a portion of the power available in the magnetic field 14, thereby leaving additional power for subsequent layers. In use, this allows power distribution to the first, second and third layers 18a, 18b and 18c in the Z-axis to be selectable by the ratio of the overall available power. For example, the conductive elements in the first layer 18a, second layer 18b and third layer 18c may be configured to control the desired level of energy distribution by layer. In this embodiment, the first layer 18a receives the original magnetic field and includes conductive elements that absorbs a first predetermined portion of the magnetic field 14 while allowing the remainder of the magnetic field 14 to pass to the second layer 18b.

Conventional inductive heating elements typically include a mass of electrically conductive material, such as a piece of foil or thin metal sheet, which generates heat in the presence of a magnetic field. In conventional applications, the conductive material produces heat primary because of eddy currents that are induced in the conductive material by the magnetic field. As a result of the electrical resistance in the conductive material, the eddy currents heat the material through Joule heating. In the context of FIG. 1, the magnetic field 14 passing through the layers 18a, 18b and 18c induced eddy currents within the conductive elements forming each layer 18a-c. The eddy currents cause the conductive elements to generate heat. The amount of heat generated by the conductive elements varies over the conductive elements, in part, in proportion to the strength of magnetic field affecting the conductive elements at any given location.

In accordance with various embodiments of the present invention, the design and configuration of the conductive elements of the heating element may be varied to control the heating profile of the package 12. For example, the amount of conductive mass in any given location over the heating element may be selected to provide the desired level of heating at that location based on the expected magnetic field. In applications that produce a multi-dimensional heating profile through the use of a plurality of different layers of conductive elements, the impact of each conductive layer on the magnetic field is taken into consideration. For example, a continuous conductive element on the first layer may prevent any meaningful amount of inductive energy from reaching the second layer. The heating element may include arrangement of conductive elements that

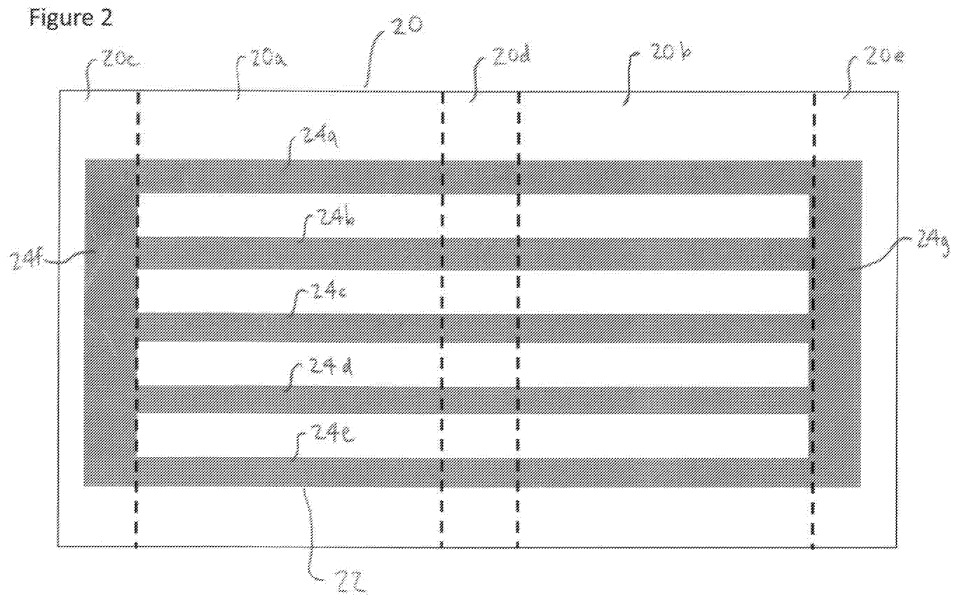

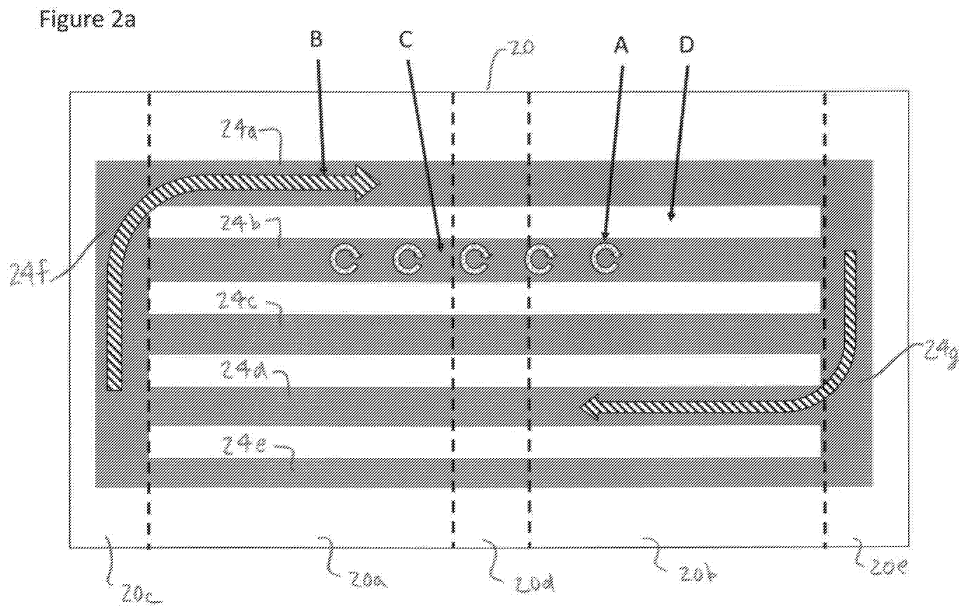

FIG. 2 is a top view of a blank 20 for a pizza box including a heating element 22 in accordance with an embodiment of the present invention. The illustration is merely representational and does not show certain sidewalls and flaps not relevant to the present invention. The broken lines represent fold lines along which the blank may be folded into a generally conventional pizza box. In this embodiment, the heating element 22 includes an arrangement of conductive elements 24a-g that extend over the panels 20a-e in the blank. When folded into a pizza box, the conductive elements 24a-g extend along the front, bottom, back and top of the box, thereby having the potential to produce heat directed toward the top, bottom, front and rear of the pizza. In the assembled pizza box, the conductive elements along the bottom panel 20a and top panel 20b form first and second layers from the perspective of inductive power supply generating a magnetic field from above or below the pizza box. For example, the pizza box may be placed on the inductive power supply 10 with its bottom panel 20a supported on the power transfer surface 16. In this embodiment, the magnetic field extends (See, for example, FIG. 1) upwardly from the power transfer surface 16 first through the bottom panel 20a and continuing upwardly through the top panel 20b.

The conductive element 24a-g are arranged in a pattern that includes gaps (or apertures) which permit portions of the magnetic field to pass through the first layer to the second layer. This allows inductive power to be shared between levels allowing heating on both sides of the package. The number, size and/or shape of the apertures for each layer may be adjustable to vary the portion of the magnetic field that is able to pass through the layer from 0% to 100%. This also shows how the pattern is distributed on a box blank before the final box folding. In addition to allowing portions of the magnetic field to pass, the pattern of conductive elements allows loop currents to be generated in the heating element by the magnetic field 14. The loop currents (unlike eddy currents) result from a uniform flow of electricity through the heating element along an electrically conductive loop in a manner similar to the inducement of electricity in an inductive receiving coil.

Referring now to FIG. 2a shows the currents that are induced within the material from the magnetic field. In areas with sufficient width that are oriented perpendicular to the magnetic field, eddy currents (A) form which create localized heating as a result of resistive losses within the material (“eddy current heating”). To increase heating from localized eddy currents the areas (C) can be made wider to intersect more of the magnetic field and can be made thicker to reduce the resistance, allowing higher amounts of eddy currents to form.

FIG. 2a also shows the loop currents (B) formed as a result of the conductive elements (C) being arranged in the form of a loop or coil, wherein the amount of current is proportional to the amount of magnetic flux passing through the open areas of the coils (D). By forming the material as a loop, current induced in the material can flow through areas that are outside of the magnetic field or in regions where the magnetic field strength is not sufficient to generate the desired heat based solely on eddy currents. Loop currents can also be used to generate heat as a result of the conductive material's resistance to the loop currents (“resistive heating”). For example, in this embodiment, loop currents generated in the first layer (e.g. the portions of the conductive elements extending along the bottom panel) will flow through the conductive elements to the second layer (e.g. the portions of the conductive elements extending along the top panel) where they can generate heat through resistive heating. To increase heating as a result of the loop currents (B), apertures (D) can be made larger to capture more magnetic flux and induce higher current, the material can be made thinner to increase the resistance in areas where heating is desired while increasing the thickness in other areas to maintain a low enough overall resistance to allow current to flow. When the heating element is constructed as shown in FIG. 2, both types of currents are induced and the structure of the conductive elements can be varied from application to application to control the amount and location of heating by balancing the width, thickness, and resistance of the material, as well as the size of the apertures.

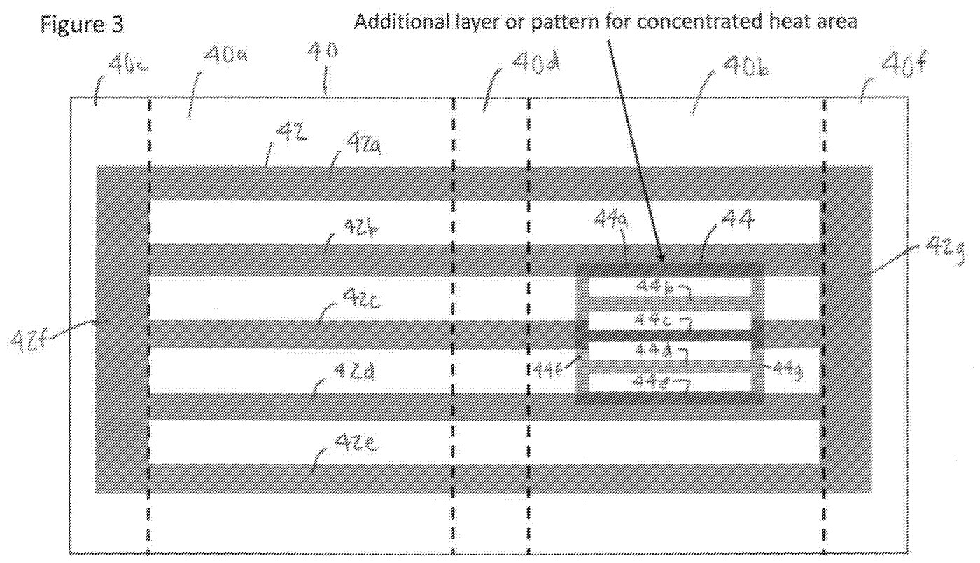

The design and configuration of the heating element can be varied from application to application to provide packaging with essentially any desired heating profile. For example, FIG. 3 shows a box blank 40 having a heating element 42 with an additional pattern of conductive elements 44 to concentrate power toward the center of a particular surface. In this embodiment, the heating element 42 includes a pattern of conductive elements 42a-g that extend over much of the package to provide some level of heating through much of the package and with a concentrated arrangement of conductive elements 44a-g disposed toward the interior of the top panel 40b to provide increased interior heating. The package 40 of this embodiment may be well suited for use in heating a cookie and other similar items where it is desirable to provide concentrated heat toward the interior of the item and a lower level of substantially uniform heat over the remainder of the item.

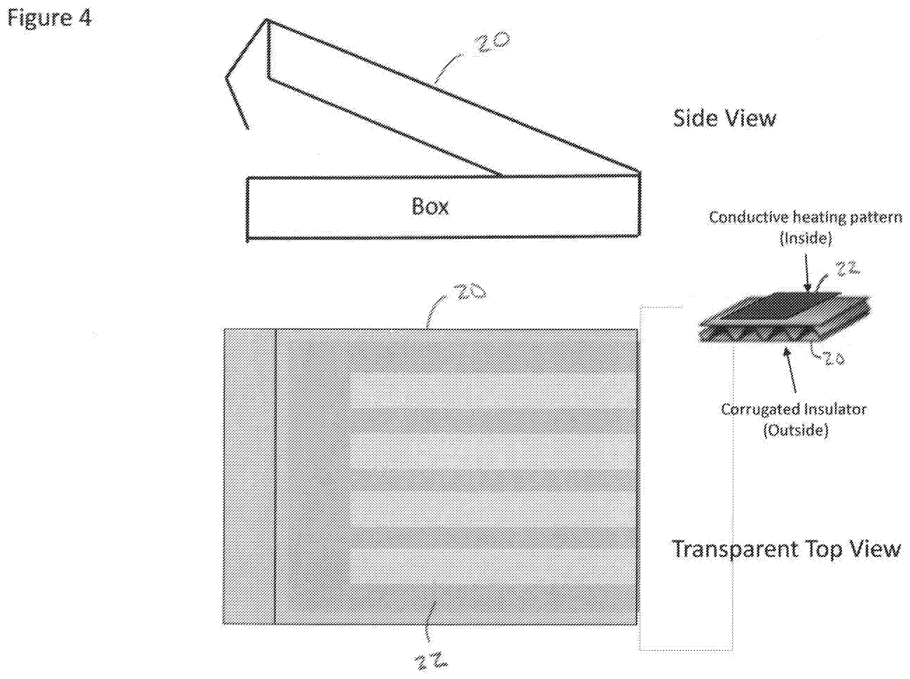

FIG. 4 shows the folded configuration of a package, such as pizza box 20, and the heating element 22 within the box. To facilitate disclosure, the package 20 is shown as being partially transparent to make visible the heating element 22 on the inside surface of the package 20. In this embodiment, the package is manufactured from cardboard, such as corrugated cardboard, and the heating element 22 is laminated to the interior surfaces of the cardboard. Positioning the heating element 22 on the interior surface is not strictly necessary, but it allows the cardboard to act as an insulator that retains the inductively generated heat inside the package. The heating element may be manufactured from essentially any conductive material and may be joined with the package using essentially any methods. For example, in the illustrated embodiment, the heating element 22 is a conductive foil or a thin sheet of conductive material that is secured to the surface of the cardboard by adhesive. As an alternative example, the heating element may be manufactured from a conductive ink that is printed directly onto the surface of the cardboard or onto an insert that is affixed to or inserted within the package. The illustrated package can be used for cookies, meat pies, pizza, sandwiches, take out boxes etc. Although the package of FIG. 4 is manufactured from cardboard, the present invention can be implemented in packages made a wide variety of alternative materials. Examples of some additional materials that might be used in producing disposable packaging include Styrofoam, chipboard, paper, paperboard and parchment paper.

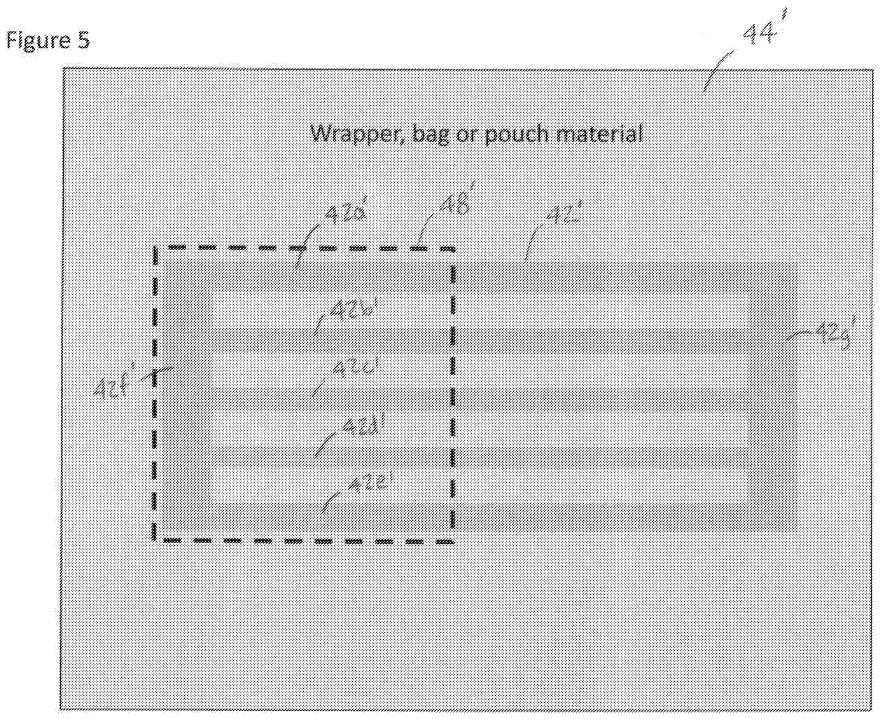

As noted above, the present invention may be incorporated into a wide range of packages of different types. For example, the present invention may be incorporate into a food wrapper or a food pouch to allow the wrapped food to be warmed or cooked. FIG. 5 is shows the heating element 42′ printed on a sheet 44′ or other flat stock of material that might be used to form a pouch, sandwich wrapper, bag or other type of packaging. As shown, the heating element 42′ may include conductive elements 42a-g′ that extend over a central portion of the sheet 44′. In this embodiment, the broken line represents the general size and shape of the item 48′ to be packaged. In use, the sheet 44′ may be wrapped around the item 48′ with the heating element 42′ wrapping fully or partially around the item 48′ to allow heating of the item 48′ from all sides. In this embodiment, the conductive elements 42a-g′ are configured to produce a combination of eddy currents and loop currents that allow the desired heating profile to be executed by the wrapper with heat generated on opposite sides the wrapped item 48′.

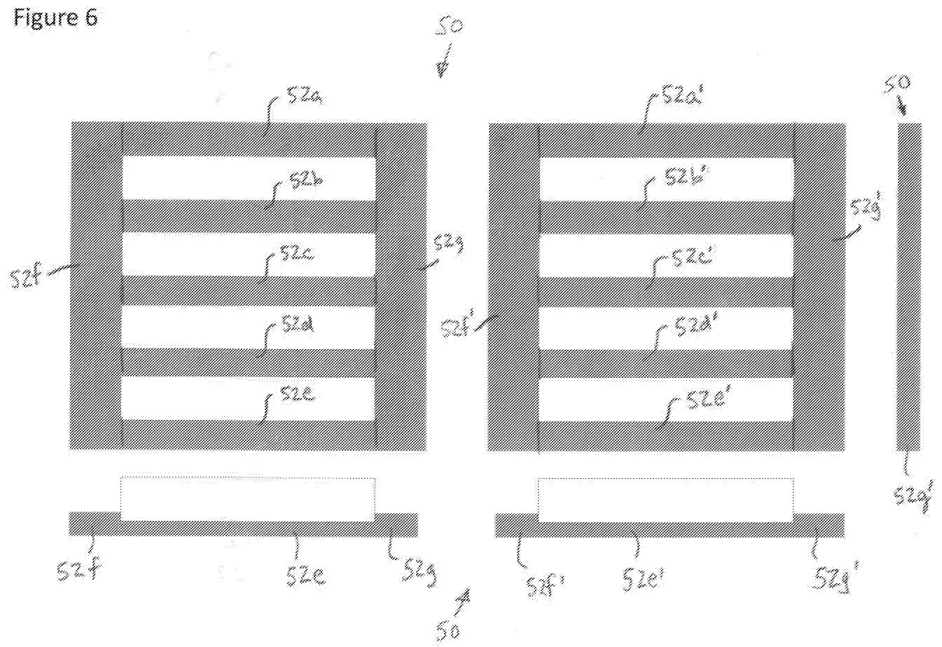

As noted above, the heating profile can be selectively controlled by varying the mass of conductive material. For example, the area and/or thickness of the conductive material can be used as controllable aspects of power coupling and distribution. Varying the mass can affect the amount of eddy current and loop currents that are induced in the conductive material, as well as affect the resistance of the material, which, in turn, influences the heat generated by the induced eddy currents and induce loop currents. In practice, varying the mass of conductive material in different regions of the heating element can be used to control the heating profile of the heating element. FIG. 6 shows a heating element 50 having separate top and bottom heating elements portions that can be, for example, disposed in the top and bottom halves of a package. In this embodiment, each heating element portion has conductive elements 52a-g and 52a-g′ of variable thickness that can enable or limit the power and distribution per layer. As shown, conductive elements 52f-g and 52f-g′ are substantially thicker than conductive elements 52a-e and 52a-e′. As a result, the loop current heating in conductive elements 52f-g and 52f-g′ would be lower than if they had the same thickness as the thinner remaining conductive elements 52a-e and 52a-e′. At the same time, the eddy current heating in conductive elements 52f-g and 52f-g′ would likely remain substantially the same as if they had the same thickness as the remaining conductive elements 52a-e and 52a-e′.

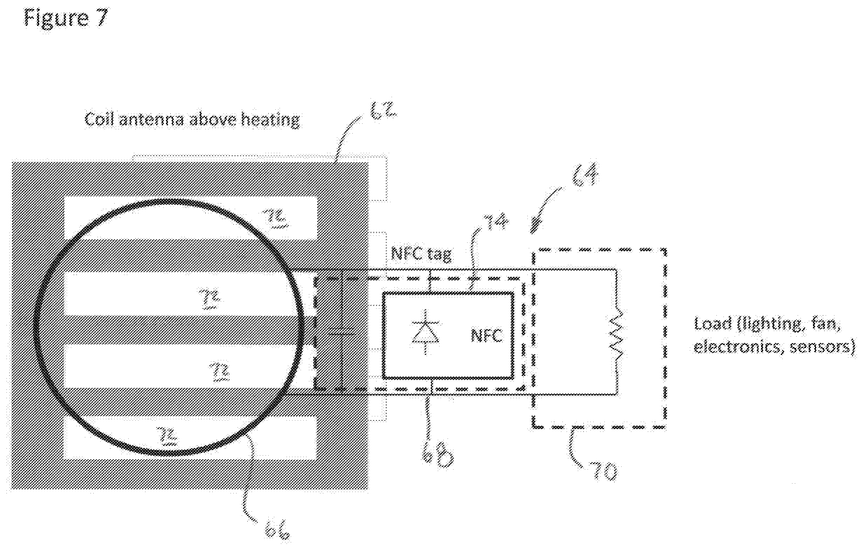

The energy available in a magnetic field may, in some embodiments of the present invention, be used for purposes other than heating. For example, a portion of the energy may be used to generate heat while another portion is used to generate electricity used to operate electronic components integrated into the package or other vessel. The supplemental electricity may be induced in the heating element and/or in a supplemental inductive receiver position within the magnetic field. FIG. 7 shows an embodiment where additional electromagnetic field is maintained to use for other purposes enabling heating and available wireless power for other uses. As shown, the embodiment of FIG. 7 include a heating element 62 and an electronic assembly 64. The heating element 62 may be integrated into a package or other vessel not shown. The electronic assembly 64 may include an inductive receiver 66 and an electronic circuit 68 that operates a load 70. The electronic assembly 64 may also be integrated into the package (or other vessel) or it may be a separate electronic device that happens to be situated in the magnetic field atop the package. In the illustrated embodiment, the electronic assembly 64 include an NFC tag 74 that is integrated into the package. The NFC tag 74 may be used to identify the package and/or to track operational data, such as data relating to time of operation, temperature and strength of magnetic field. In this embodiment, the electronic circuit 68 also includes a load, such as lighting, a fan, one or more sensors or essentially any other desired electronics.

In this embodiment, the heating element 62 has apertures 72 that allow a portion of the magnetic field to pass through heating element 62 to the inductive receiver 66. The magnetic field induces current in the inductive receiver 66. The current induced in the inductive receiver 66 can be used in essentially any manner. For example, the electronic circuit 68 may include a rectifier that provides DC current to the electronic circuit 68, which may use it to power a wide range of electronic components. The characteristics of the magnetic field, as well as the mass and arrangement of conductive material in the heating element 62, are determined in accordance with the principles of the present invention to provide the desired heating profile while allowing sufficient magnetic field to pass through the heating element 62 to generate the desired power in the inductive receiver 66.

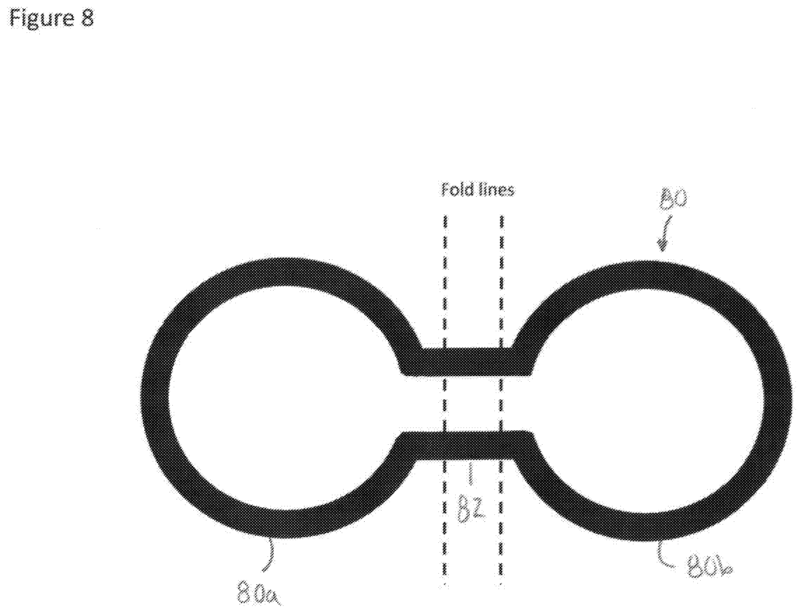

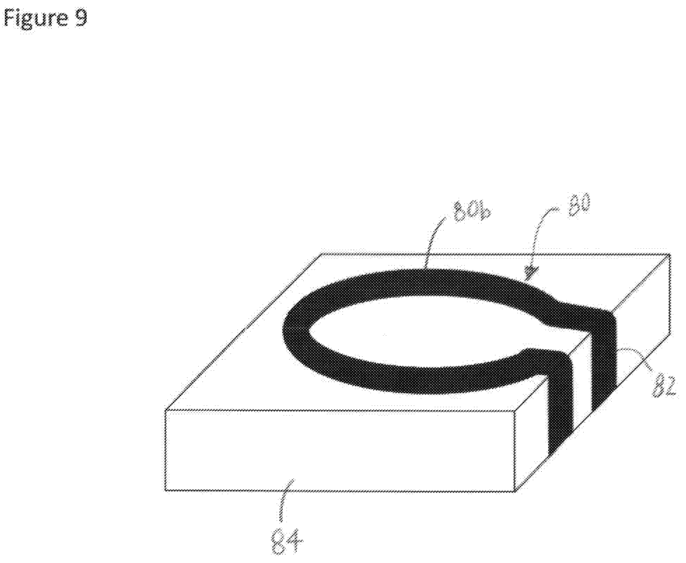

FIG. 8 shows the construction of a heating element 80, such as a conductive metal foil, wherein two loops 80a and 80b are used to receive inductive energy and are connected to allow current to flow through both loops 80a-b, thus heating all areas of the conductive loop 80a-b. A fold area 82 is provided so that the foil loop can be placed on the inside of a folded paperboard container (or other similar package) to provide heating to the top and bottom sides of a food product situated in the container. The conductive foil is conductive enough to allow current to flow but resistive enough to cause heating along the length of the material (0.1-2 ohms for example). FIG. 9 shows the heating element 80 of FIG. 8 integrated into a folded paperboard package 84. In this embodiment, an inductive transmitting coil may be placed on both sides of the package to induce current in both the top and bottom portions of the loop, or a transmitting coil may be place on either the top or bottom but not both. When an inductive transmitting coils are located on opposite sides of the package, the orientation of the fields may be coordinated so that the current induced in the top and bottom loops are additive. When a single inductive transmitting coil is used, the current induced on one side of the loop is conducted to the other side, providing energy for resistive heating along the entire length of the loop. In such embodiments, the characteristics of the two loops may vary to facilitate the inducement of current in one loop and resistive heating in the other loop. For example, when a single inductive power supply is located below the package, the top loop may be configured to provide greater resistive heating than the bottom coil. For instance, in some applications, the top loop may be thinner than the bottom loop to enhance resistive heating in top loop.

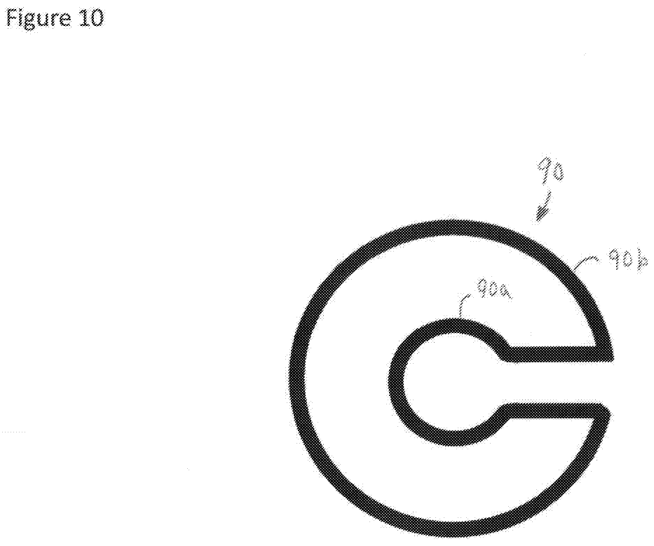

FIG. 10 shows an alternate embodiment wherein a heating element 90 has an inner coil loop 90a and an outer coil loop 90b that is used to heat a large surface area. In this embodiment, if a large surface area must be heated, a single loop may not provide heating across enough area to evenly heat the object. While a continuous foil may be used, a continuous foil prevents more precise control over the areas that receive heat. To provide heating across a larger area without using a continuous foil, the foil or printed heating element 90 may be in the form of a coil may have an outer loop 90b which receives the majority of the inductive energy and an inner loop 90a that has little interaction with the magnetic field but can still provide resistive heating using the current flowing through the coil. In this embodiment, the inductive power supply and the heating element can be designed to interact to provide the desired heating profile. For example, the characteristics of the magnetic field and the characteristics of the heating element may be selected to produce the desired heating profile. More specifically, the size, shape and/or configuration of the two loops 90a and 90b, as well as the size, shape, configuration and/or magnitude of the magnetic field, can be predetermined and selected to produce the desired heating profile.

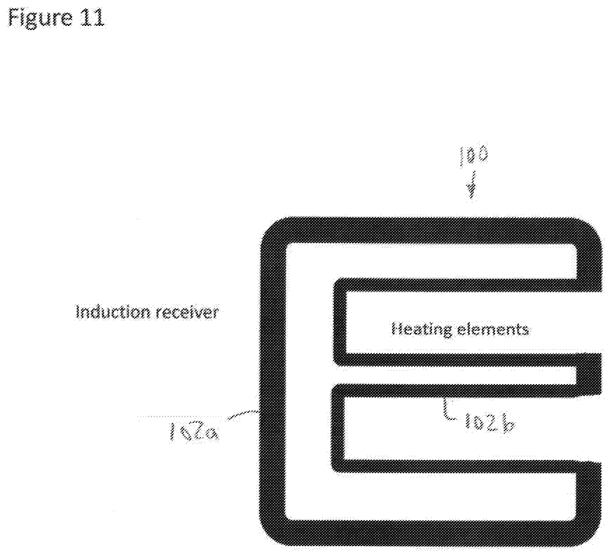

As noted, variations in the mass of conductive material within the heating element can be used to vary the heating profile. For example, FIG. 11 shows an embodiment of a heating element 100 that is generally in the form of a coil or loop in which an outer portion 102a of the coil is wider than an inner portion 102b. This gives the outer portion 102a a lower impedance that can receive the inductive energy from the magnetic field without significantly heating. The inner portion 102b, which is thinner, has greater impedance and can therefore use the induced current to generate heat in more localized areas. These localized heating areas can be used to control where the heat is directed into the product and can be used to create localized browning or discoloring of a food product to mimic griddle marks or to add images or text. The heating element 100 of FIG. 11 is merely exemplary and variations in conductive mass, including variations in width and thickness, can be used to assist in obtaining essentially any desired heating profile.

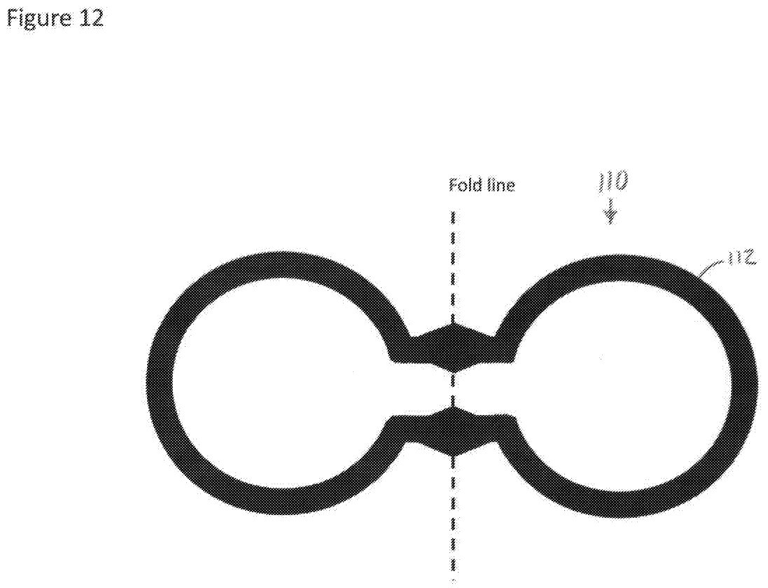

Variations in the conductive mass of the heating element may be used to address other potential complications associated with the design and configuration of inductively heated packages. FIG. 12 shows an embodiment of a heating element 110 in the shape of a coil or loop wherein the conductive elements 112 of the coil are made wider at the folding areas (denoted by the fold line). This is done because when a thin coil is folded, the fold can create localized heating areas due to the skin and proximity effects of conductors being bent sharply. This wider portion can be used to reduce the impedance of these areas to prevent localized heating from occurring at these folds if they are undesired areas of heating. Additionally or alternatively, the impedance of the conductive material at the fold line can be reduced by increasing the thickness of the material.

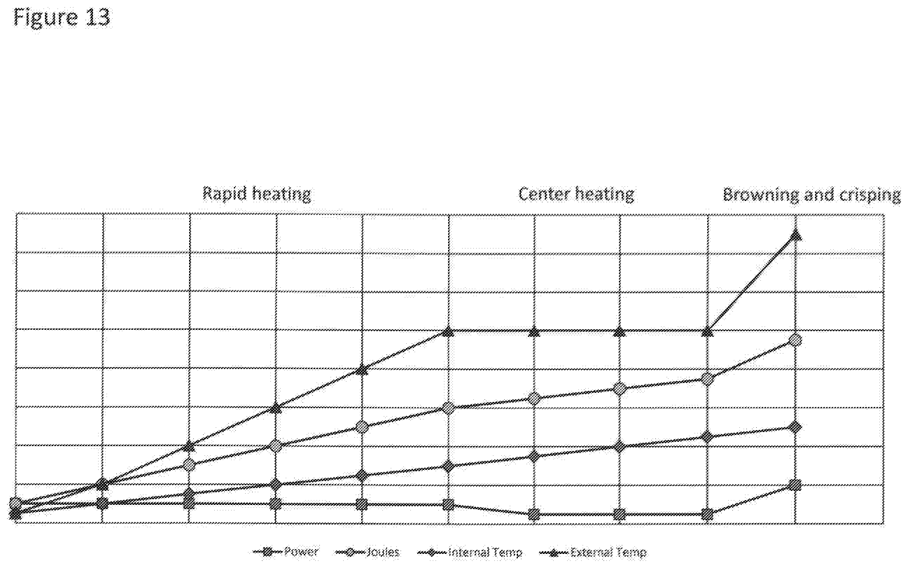

In another aspect of the present invention, the inductive heating system may be configured to assist in controlling heating of the packaged item in realtime. In one embodiment, the package includes a temperature sensor configured to measure the outside temperature of the packaged item, and the system is provided with the ability to determine and record the amount of energy delivered to the food product over time. In implementing this aspect of the present invention, the heating characteristics of the packaged food product can be used to develop a heating algorithm. FIG. 13 shows an example of a heating profile over time of a frozen product showing the power (Watts), cumulative energy (Joules), temperature of the outside of the product near the heating coil, and temperature of the inside of the product. As shown, the middle temperature of the product rises much more slowly than the outside due to the absorption rate of heat within a food product. The heating profile shown in FIG. 13 is merely exemplary and different food products may have different heating profiles.

In this embodiment, the food package has a temperature sensor located near the outside of the food product, allowing the system to know the temperature of the outside of the food product. However, the inside temperature is not know because a temperature sensor cannot be placed there. When a product is heated while on the induction power supply, the inside temperature can be estimated based on the total power delivered and the time over which it has been heated. However, if the food product is removed before it is done being heated and then placed back on the induction base, it is difficult to know what the internal temperature of the food product is. To solve this, the system records how much total energy has been transmitted and correlates it to the outside temperature of the food product to estimate the internal temperature. For example, during the “center heating” phase the power (W) is reduced to keep the outside temperature of the food stable while the inside of the food continues to heat up. By recording how much total energy has been transmitted and correlating it to outside food temperature, the system can estimate the internal temperature of the food product. For example, if the product is a frozen food and the temperature sensor indicates that the outside of the food is room temperature (˜25 C) and 2 kJ have been delivered to the product already (200 W for 10 seconds), it can be estimate that the inside of the product is still colder than the outside. However, if the temperature sensor indicates that the outside of the food is room temperature (˜25 C) and no energy has been delivered to the product, it can be determined that the inside of the product is similar to the outside temperature as the product has likely defrosted slowly in a room temperature environment. The energy delivered can be recorded within the induction base, on the NFC tag within the food products packaging, or both. In addition, the induction base may record how much time the product was removed from the base to more accurate estimate how much the product may have cooled off during that time, since the outside of the product may cool off but the inside of the product my continue to heat up as the heat continues to spread within the food product. When an NFC tag is includes, the system may be configured to exchange communication with the NFC tag through the inductive power supply or the system may include a separate NFC transceiver that allows the inductive power supply to communicate with the NFC tag separately from the inductive power supply. The inductive power supply and NFC tag may communicate using essentially any current or future conventional NFC communication protocol. If desired, the inductive power supply and NFC tag may communicate using a proprietary communication protocol.

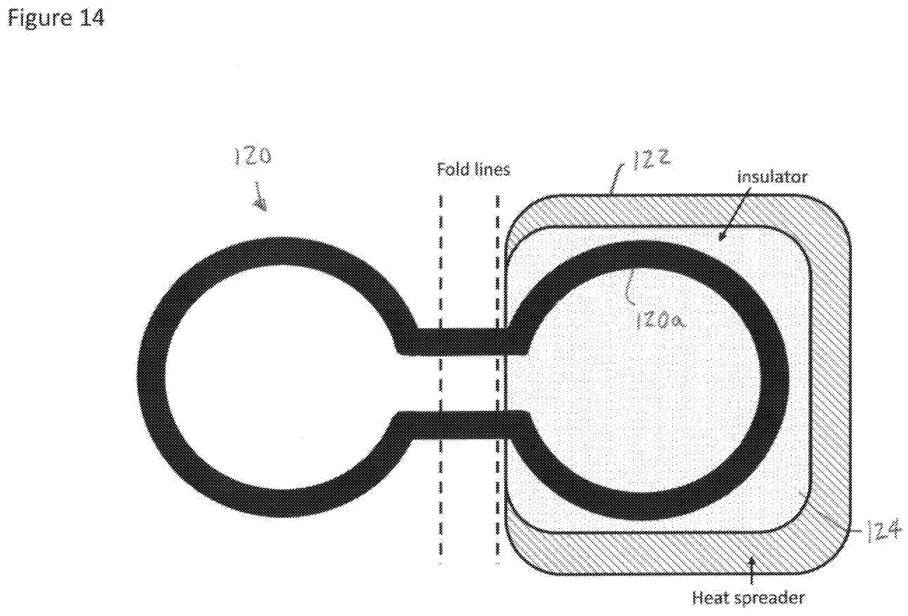

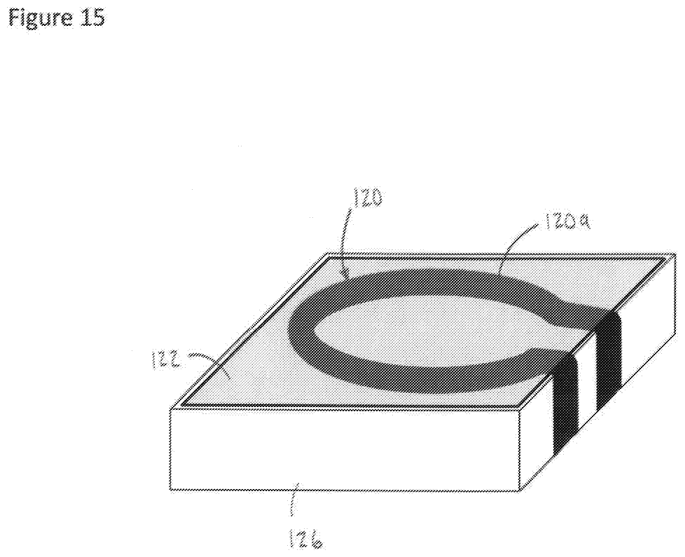

In alternative embodiments of the present invention, the inductively heated package may include supplemental components that assist in distributing heat. For example, FIG. 14 shows an embodiment of a heating element 120 wherein a material 122 with low thermal resistance may be placed behind a portion of the coil 120a to provide more even heat distribution within the package 126. FIG. 15 shows the material 122 located on the top side of the package 126. If the material is electrically conductive, it cannot be located behind the coil when placed directly above the inductive transmitting coil or the material will shunt the magnetic field, preventing current from flowing in the coil. To address this issue, an insulator 124 may be located between the coil portion 120a and the material 122 to prevent electrical conductivity from altering the resistance of the heating element 120, thus the heating element generates heat while the material 122 dissipates that heat more evenly across the surface of the package 126. In this embodiment, the heating distribution material may be foil or silver conductive ink and the insulator may be PET (polyethylene terephthalate) film. Although the illustrated embodiment shows the insulator 124 as a sheet of material, the insulator may be of essentially any configuration that provides the desired electrical insulation between the heating element and the heat distribution material. For example, in an alternative embodiment, an insulating material may be applied to the surface of the coil portion 120a that would be in engagement with the heat distribution material. The number, size, shape and configuration of the heat distributing material and corresponding insulator may vary from application to application as desired to implement the desired heating profile. For example, in the illustrated embodiment, the heat distributing material 122 is located adjacent only one coil portion 120a, but it could extend over the entire heating element or a second separate material 122 could be disposed adjacent the second coil portion 120b.

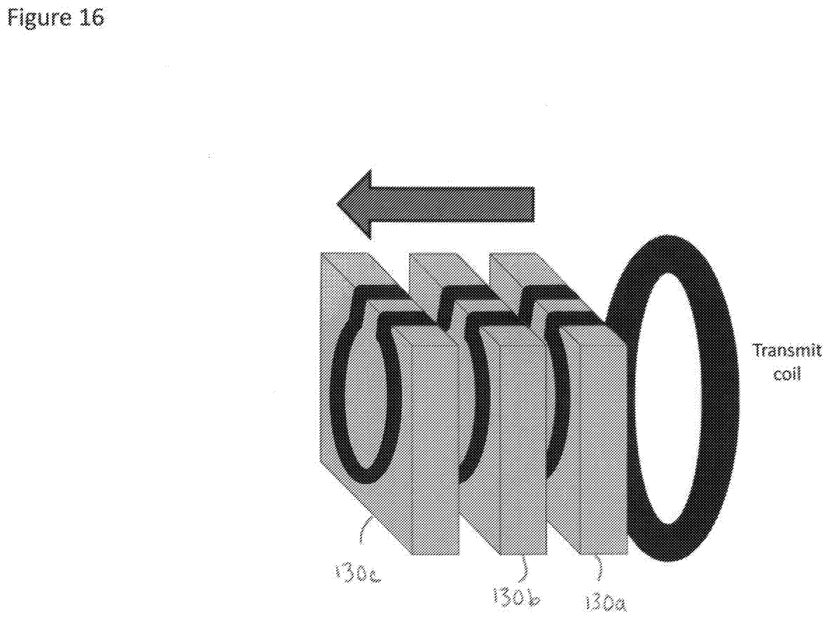

In alternative embodiments, the system may be configured to heat a plurality of stacked packages by relaying the magnetic field from one stacked package to the next. For example, each heating element may include a first coil portion configured to generate loop currents in response to a magnetic field and a second coil portion configured to product a supplemental magnetic field in response to the flow of the loop currents. This configuration allows each inductively heated package to receive power and relay a portion of that power to an adjacent package. As an example, FIG. 16 shows several packages 130a, 130b and 130c stacked such that the current induced in the first package 130a (nearest the transmitting coil) is used to inductively transfer power to the second package 130b (next to it), and the current induced in the second package 130b is used to inductively transfer power to the third package 130c. In this embodiment, each package uses a portion of the energy received and converts it to resistive heating within the heating element. As the energy is transmitted from package to package, the total amount of energy received within each subsequent package is reduced. When stacked vertically, this allows the bottom package to heat the most, and then once it is removed the remaining packages drop down and now the next package receives the greatest amount of heating. This can be particularly useful in the context of a food delivery service that delivers food to multiple locations in a single trip. In this context, the packages can be stacked on the inductive power supply in the order in which they are to be delivered with the packages being delivered first toward the bottom. With a pizza delivery service, for example, this allows each pizza to initially be kept warm and heated most just before it is delivered. The amount of power provided by the inductive power supply and the ratio of energy used for heating versus energy transferred to the next package can be tuned from application to application, as desired.

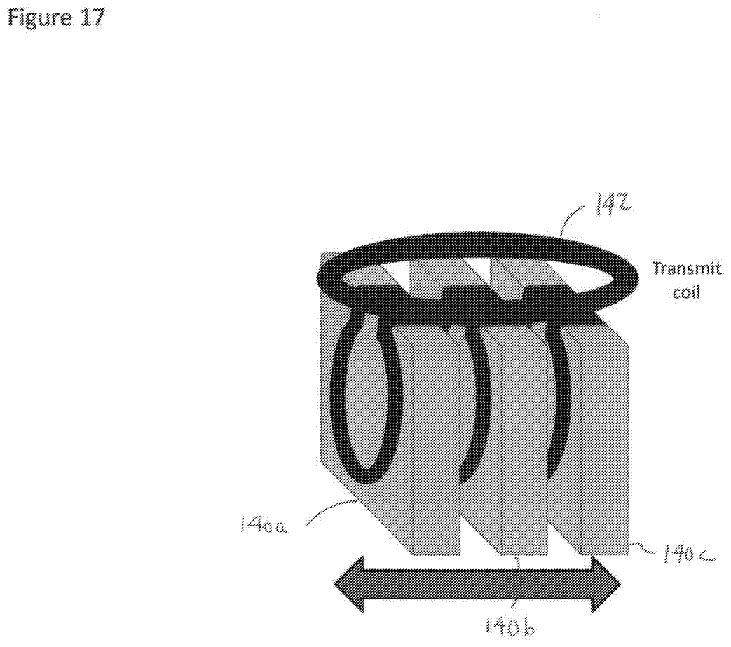

The embodiment of FIG. 16 shows the inductive power supply disposed toward one end of a stack of inductively heated packages. In alternative embodiments, the inductive power supply may be located in a different location, or multiple inductive power supplies can be used to power a plurality of packages. For example, FIG. 17 shows several packages 140a-c stacked such that an edge portion of each package 140a-c is aligned with the transmitting coil 142 of an inductive power supply such that energy can be delivered to each package 140a-c simultaneously. In addition, the heating elements within each package 140a-c can include coil portions configured to also transfer energy to adjacent packages, allowing energy delivery to be either shared amongst the containers or to allow energy to be directed more to one container or another. As discussed elsewhere in this disclosure, the design and configuration of the heating elements can be varied to provide the desired level of heating and the desired level of power transfer from one package to the next.

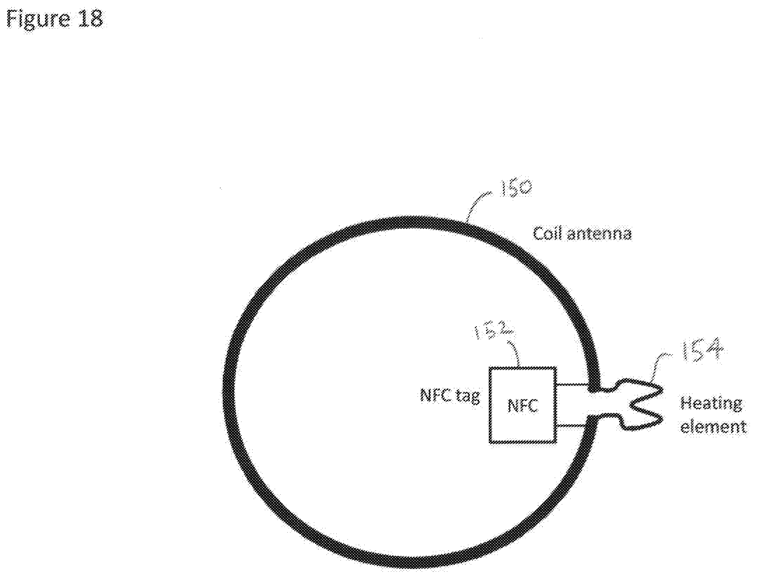

As discussed above, the present invention may be implemented in systems that include an NFC tag or other similar electronic device, such as an RFID tag or other electronic device that is powered by the magnetic field. In one embodiment of the present invention, the inductively heated package includes a coil antenna that may be used to provide power to a resistive heating element or as the antenna for an NFC tag. FIG. 18 shows a heating embodiment wherein a coil antenna 150 is connected to both an NFC tag 152 and a heating element 154. Normally, an NFC tag requires an antenna that is not terminated with a short or resistive load so that the induced voltage on the antenna is maximized when receiving and transmitting information. In this embodiment, the heating element 154 has a high enough resistance and inductance at the NFC frequency (13.56 MHz) to prevent significant loss of voltage across the antenna 150 while providing a low enough impedance at the heating frequency (for example, 50 kHz) to allow the induced current to heat the materials of the coil antenna 150 and the heating element 154. The coil antenna 150 and heating element 154 may be made from different materials or they may be made from the same material. For example, an aluminum foil may be used to create a coil antenna 150 with a wide trace with large radii for a low impedance antenna while the heating element 154 may be made from the same aluminum foil but may be thinner to create higher resistance and may use a back-and-forth design that causes high proximity and skin effect impedance at the NFC frequencies. This embodiment allows a single coil to be selectively used as either the NFC antenna or the induction heating receiver depending on the frequency of the magnetic field.

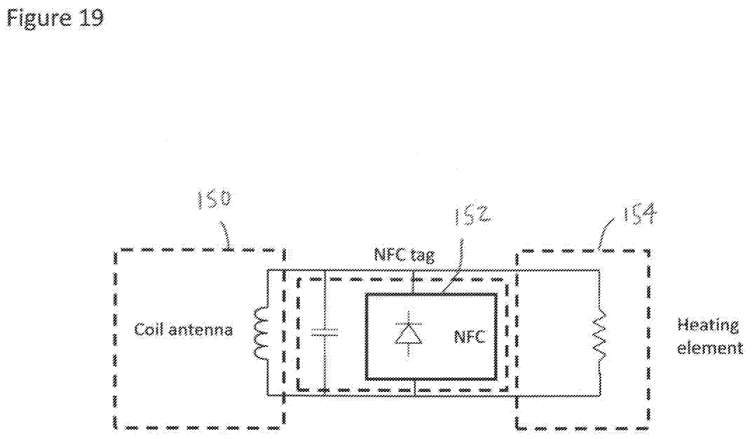

FIG. 19 shows the equivalent circuit for the embodiment of FIG. 18 at the heating frequency wherein the heating element 154 appears as a resistance. In this embodiment, the majority of the current induced in the coil antenna 150 flows through the heating element 154 with minimum current flow through the capacitor of the NFC tag 152 as the resonance frequency of the RLC circuit is significantly higher than the heating frequency.

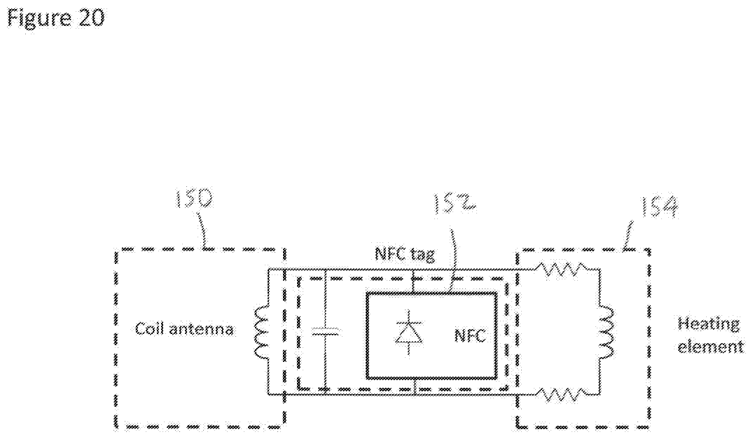

FIG. 20 shows the equivalent circuit for the embodiment of FIG. 18 at the NFC frequency wherein the construction of the heating element 154 includes back-and-forth traces causes significantly higher resistance as well as inductance. The impedance of the heating element 154 becomes high enough that the majority of the current flows through the coil antenna 150 and NFC tag 152 (capacitor and rectifier) as the LC resonant circuit formed by the tag 152 and coil antenna 150 is at or near the operating frequency of the tag 152.

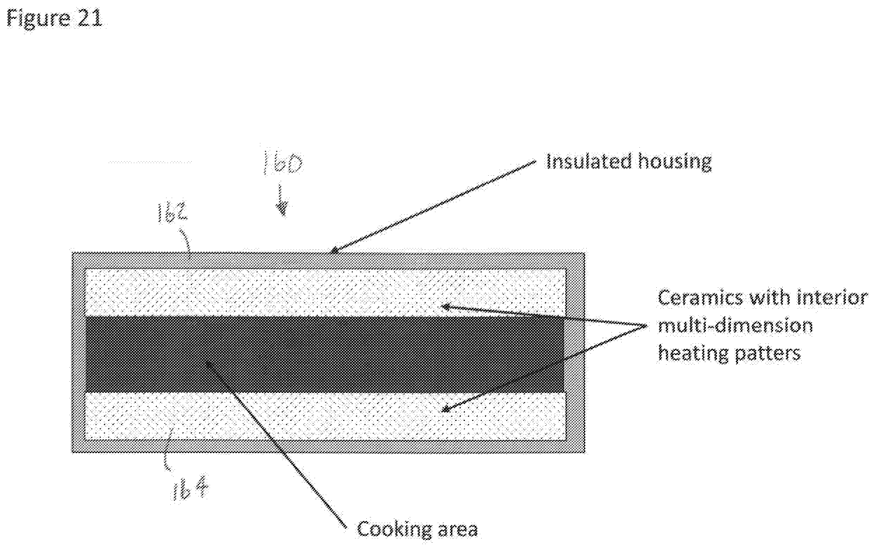

Although the present invention may be implemented in simple, disposable inductively heated packaging, the present invention may also be incorporated into other types of inductively heated vessels or containers, including re-usable vessels. For example, the present invention may be incorporated into an inductively heated vessel capable of providing oven-like cooking and heating functionality. For example, FIG. 21 shows a multidimensional inductively heated vessel 160 (or cooking device) that includes an insulated cover 162 and internal ceramic layers 164. The insulated housing 162 may be essentially any desired insulating material that helps to retain heat. For example, insulating foams and other rigid materials may be used when a rigid countertop vessel is desired and soft, flexible insulating materials (e.g. conventional insulating bag) may be used when a soft, portable vessel is desired. The internal ceramic layers 164 help to provide more uniform heat distribution to allow even heating for pizzas, sandwiches or other products. The ceramic layers 164 may include interior multi-dimensional conductive elements that are configured to provide the desired heating profile. The ceramic layers 164 may include a fired glaze (not shown) that covers all or a portion of the outer surfaces of the ceramic material. The conductive elements may be embedded within the ceramic materials, between the ceramic material and the fired glaze or essentially any combination. In alternative embodiments, the ceramic layers 164 may be replaced by other heat distribution materials, such as one or more layers of material that has high heat conductivity properties.

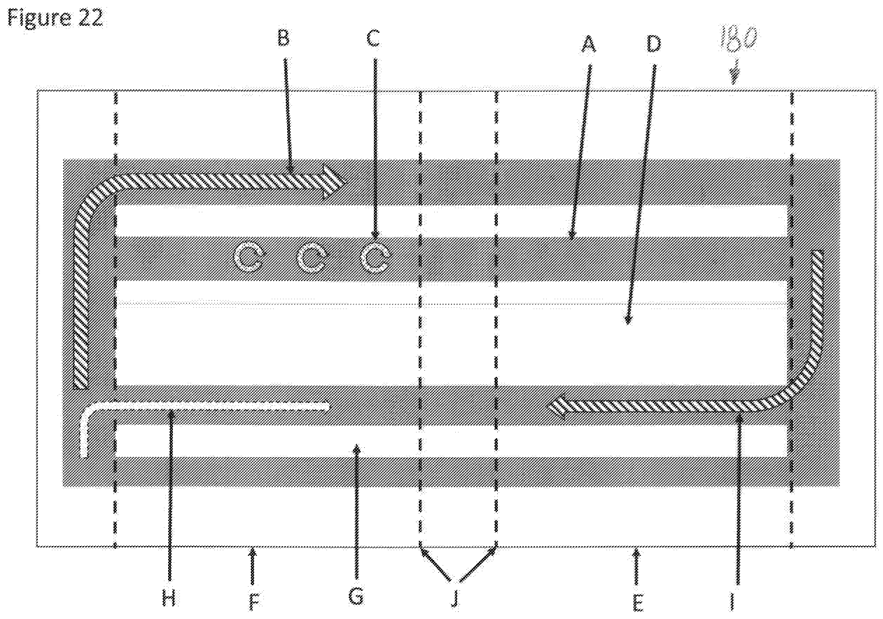

As discussed above, the design and configuration of the conductive elements can be varied to affect the heating profile of an inductively heated package. FIG. 22 shows an alternative embodiment of a multidimensional inductively heated package 180 wherein a top portion F and a bottom portion E both have strips of metallic material C applied to the inside of the container. The strips form a grid pattern connected at the ends forming several loops of material. The material is heated using a magnetic field applied to the bottom of the package underneath area E, which induces localized eddy currents A as well as loop currents B. The localized eddy currents are generated in areas wherein the material is of a sufficient thickness and width to generate eddy currents at the induction frequency, and where sufficient magnetic field strength is present. Loop currents are generated around apertures such as D and G, wherein the material is of sufficient conductivity and formed in a continuous conductive loop to allow currents to form when sufficient magnetic field passed through a portion of the aperture. In the embodiment shown, the loop currents B and I flow in the same direction due to magnetic field passing through aperture D. In addition, loop current H is formed by magnetic field passing through aperture G. This loop current is lower than the opposing current I due to the smaller aperture, resulting in a net current in the direction of I at an amplitude of I less H. When the package is folded at fold lines J, the aperture D forces loop currents in one direction on the bottom of the package E and in an opposite direction at the top of the package F, causing additional changes in loop currents. The top of the package F is farther from the transmitting coil resulting in lower magnetic field strength passing through the aperture D at the top of the package, create a net loop current flow following the direction defined by the magnetic flux through aperture D at the bottom of the package E.

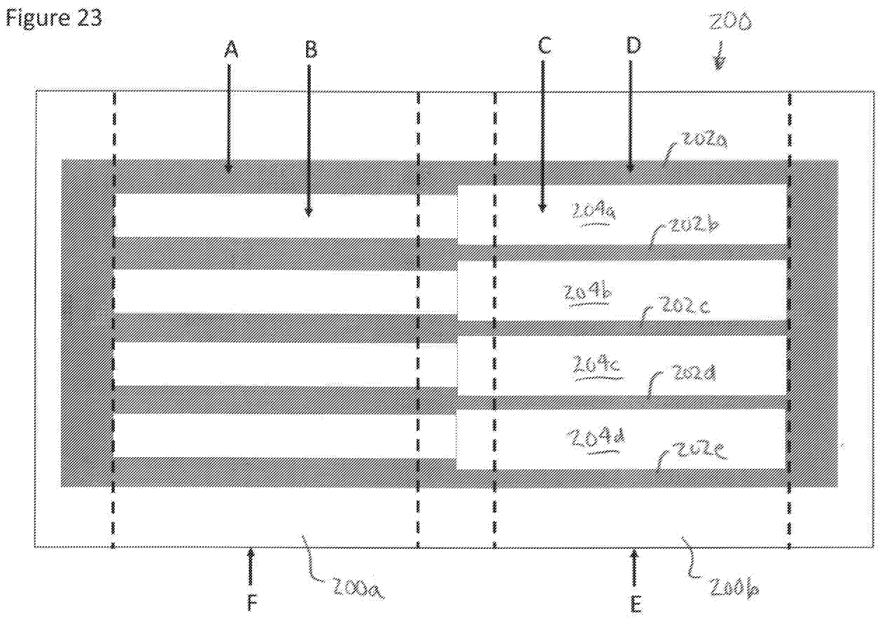

As previously noted, multidimensional packages create a number of complexities that are not present in packages that have only a single layer of conductive material. For example, the conductive elements in a one layer of conductive material may absorb the portion of the magnetic field that interacts with that layer, thereby reducing the level of magnetic field reaching any conductive elements in successive layers. When this is undesirable, the heating element can be configured so that the conductive elements of successive layers are not coextensive with the conductive elements of the first layer. For example, FIG. 23 shows a multidimensional package 200 wherein the conducting elements 202a-e are varied in width between the top 200a of the package 200 and bottom 200b of the package 200 to absorb different amounts of the magnetic field thus resulting in eddy current heating that can be adjusted between the top and bottom of the package. As the magnetic field passes through the bottom 200b of the package 200, some of the field is absorbed by the portions of the conductive elements 202a-e situated in the bottom 200b while some of the remaining field passes through apertures 204a-d to the second layer. The field that passes through the apertures 204a-d is absorbed by the portions of the conductive elements 202a-e in the top 200a of the package 200. Because the portions of the conductive elements 202a-e in the top 200a are wider than the portions of the conductive elements 202a-e on the bottom 200b, they are able to absorb a greater percentage of the magnetic field. When the top 200a of the package 200 is in close proximity to the bottom 200b of the package 200 and the resulting magnetic field strength is similar in both areas, the top 202a experiences higher levels of heating due to its increased absorption. However, if the top 200a is at an increased distance from the transmitting coil (not shown), the lower magnetic field strength may result in similar heating rate or a lower heating rate even when the portions of the conductive elements 202a-e in the top 200a of the package 200 cover more surface area than the portions of the conductive elements 202a-e in the bottom 200b of the package 200. As distance is increased, the surface area of the conductive elements at the top of the package may need to be increased to maintain heat absorption, or the conductive elements at the bottom of the package may need to be reduced, or both. When more heat is desired at the top 200a of the package 200, the ratio of the surface area of the top conductive elements 202a-e is increased relative to the bottom conductive elements 202a-e. If the top conductive elements 202a-e are placed at a distance at which the magnetic field strength is too weak to induce the desired heating through eddy currents, the materials could be designed to create loop currents that force current through the areas where heating is desired.

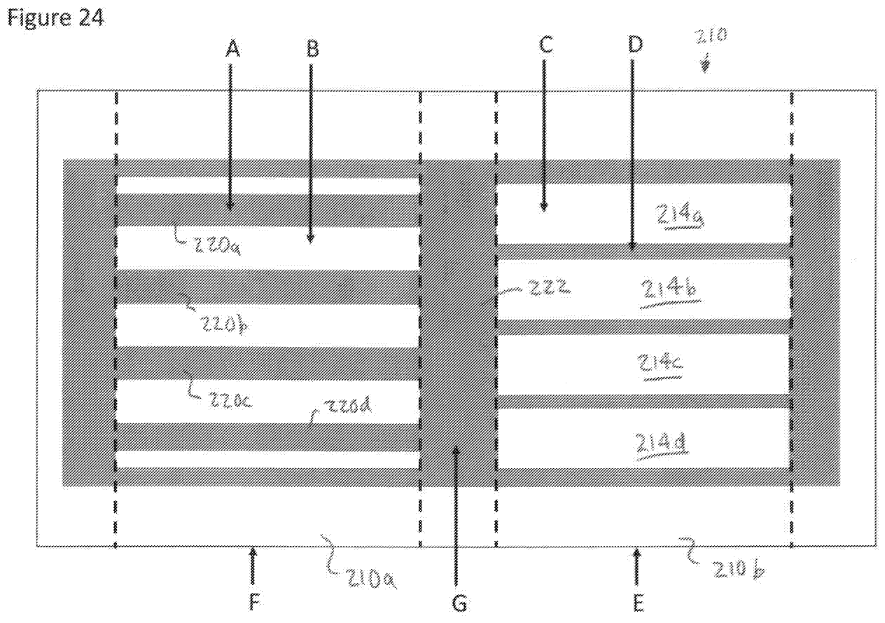

Variations in the width of the conductive elements is only one exemplary way to help tune power absorption and heating on different layers of the package. For example, another method is to offset the conductive elements in the top layer from the conductive elements in the bottom layer. For example, FIG. 24 shows an alternative inductively heated package 210 that is similar to the package of FIG. 23. In this embodiment, the conductive elements 220b-e of the second layer (or top layer) are aligned with the apertures 214a-d of the adjacent layer (or first layer), such that the top conductive areas 220b-e become vertically aligned with the lower apertures 214a-d and top apertures 218b-d are aligned with the lower conductive areas 212b-d when the top 201a the package 210 is folded and aligned over the bottom 210b of the package 210. In addition, the width of the top conductive areas 220b-d are made to be wider than the lower conductive areas 214b-d to increase the amount of magnetic field absorption at the top 210a of the package 210 vs the bottom 210b. If the magnetic field strength is similar at the top 210a and bottom 210b of the package 210, this results in increased eddy current heating at the top 210a of the package 210. In addition, a center conductor 222 is included to prevent loop current cancellation between the top 210a and bottom 210b conductive loops within the package 210.

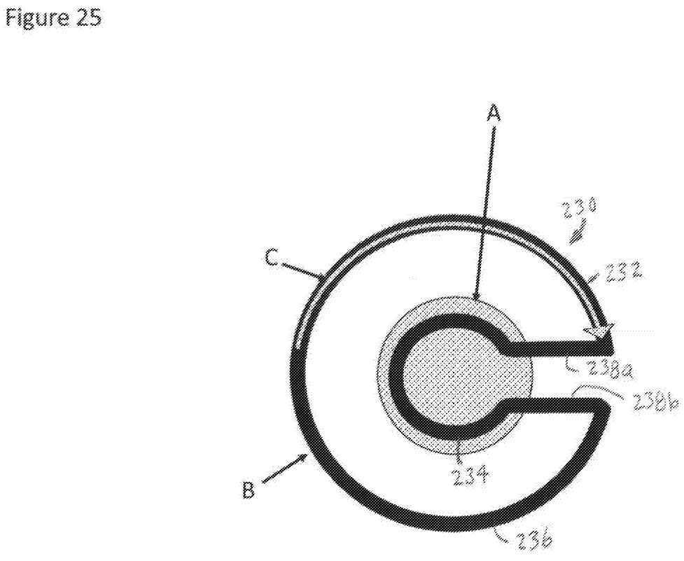

FIG. 25 shows an alternative embodiment of the present invention intended for use in applications where the transmitting coil of the inductive power supply is smaller than the desired heating area. In this embodiment, the heating element 230 include a conductive element 232 that is configured in the form of an inner loop 234 and an outer loop 236 that are joined along conductive elements 238a and 238b. In this embodiment, the heating element 230 is constructed with the inner loop 234 situated in the magnetic field A and the outer loop 236 disposed outside the magnetic field A. In use, the magnetic field induces loop currents in the inner loop 234 that flow through the inner loop 234 and the outer loop 236. In this embodiment, the outer loop 236 is configured to generate heat in response to the flow of these loop currents. For example, the characteristics of the outer loop 236 (e.g. type of conductive material, material thickness, material width, etc.) may be selected so that the outer loop 236 has the resistance/impedance needed to provide the desired heating profile. As can be seen, this design is constructed in a continuous loop with inner and outer portions that are connected in series, but constructed in a single layer. Alternatively, two loops disposed in two layers may be configured in series with the induced currents flowing in the same clockwise or counterclockwise direction in both loops. One method for implementing this approach is to have the conductive traces cross over one another between the two loops in a figure-8-like manner. This method may require an insulator to be interposed between the traces at the point of cross over, which could add cost and manufacturing steps to the package.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are as follows:

1. A heating system comprising:
an inductive power supply having a power transfer surface and a inductive transmitter generating an electromagnetic field about the power transfer surface; and
an inductively heated package configured to package a product, the package having a heating element configured to heat the product when in the presence of the electromagnetic field, the heating element having a plurality of conductive elements arranged in a pattern predetermined to heat the product in accordance with a predetermined heating profile.

2. The heating system of claim 1 wherein the heating element includes a first plurality of conductive elements arranged in a first layer disposed on a first side of the product and a second plurality of conductive elements arranged in a second layer disposed on a second side of the product.

3. The heating system of claim 2 wherein the heating element includes at least one conductive element arranged in a conductive loop, whereby loop currents are induced in the conductive loop when in the presence of the electromagnetic field.

4. The heating system of claim 3 wherein at least a first portion of the conductive loop is in a first layer disposed on a first side of the product and a second portion of the conductive loop is in a second layer disposed on a second side of the product.

5. The heating system of claim 2 wherein the plurality of first conductive elements define a first aperture and the plurality of second conductive elements includes at least one conductive element aligned with the first aperture.

6. The heating system of claim 2 wherein the plurality of first conductive elements define a plurality of apertures and the plurality of second conductive elements includes a plurality of conductive elements aligned with the plurality of apertures.

7. The heating system of claim 1 wherein the conductive elements are arranged in a non-uniform pattern with at least one aperture.

8. The heating system of claim 1 wherein the conductive elements include a first conductive loop portion and a second conductive loop portion arranged in series.

9. The heating system of claim 8 wherein the first conductive loop portion is disposed inside the second conductive loop.

10. The heating system of claim 1 wherein the conductive element includes a first conductive loop portion disposed on a first side of the package and a second conductive loop portion disposed on a second side of the package.

11. The heating system of claim 1 wherein at least one of the thickness and the width of the conductive element varies.

12. The heating system of claim 11 wherein conductive elements are configured to induce eddy currents and loop currents.

13. The heating system of claim 1 further including an inductive receiver and an electronic circuit, the inductive receiver configured to generate electricity to power the electronic circuit.

14. The heating system of claim 1 wherein at least one conductive element is folded along a fold line, the conductive element having greater width or greater thickness along the fold line.

15. The heating system of claim 1 further including a heat distributor disposed adjacent to at least a portion of the heating element.

16. The heating system of claim 15 further including an insulator disposed between the heating element and the heat distributor.

17. The heating system of claim 1 wherein the conductive element includes a first conductive loop portion disposed on a first side of the package and a second conductive loop portion disposed on a second side of the package, the second conductive loop portion generating a supplemental electromagnetic field in response to loop currents induced within the heating element.

18. The heating system of claim 17 further including a second inductively heated packaged disposed in the supplemental electromagnetic field.

19. An inductively heated package comprising:
an inductive receiver for receiving power from an electromagnetic field;
an electronic circuit connected in series with the inductive receiver; and
a heating element connected in series with the inductive receiver and in parallel with the electronic circuit, the heating element having an impedance that varies with the frequency of the electromagnetic field, the heating element having a first impedance at a first frequency to prevent significant loss of voltage at the first frequency, the heating element having a second impedance at a second frequency to allow the induced current to heat the heating element at the second frequency.

20. The inductively heated package of claim 19 wherein the inductive receiver is a coil.

21. The inductively heated package of claim 20 wherein the electronic circuit is an NFC tag.

22. The inductively heated package of claim 21 wherein the heating element includes a plurality of conductive elements.

23. An inductively heated vessel comprising:
an insulating housing having an interior configured to receive a product to be inductively heated;
a heating element having a first plurality of conductive elements arranged on a first layer and a second plurality of conductive elements arranged on a second layer, the conductive elements arranged in a pattern predetermined to heat the product in accordance with a predetermined heating profile;
a first heat distributor disposed adjacent the first layer; and
a second heat distributor disposed adjacent the second layer.

24. The inductively heated vessel of claim 23 wherein at least one of the first heat distributor and the second distributor is ceramic.

25. An inductively heated vessel comprising:
a package for packaging a product; and
a heating element configured to heat the product when in the presence of an electromagnetic field, the heating element having a plurality of conductive elements arranged in a pattern predetermined to heat the product in accordance with a predetermined heating profile.

26. The inductively heated vessel of claim 25 wherein the package is a pizza box.

27. The inductively heated vessel of claim 25 wherein the package is a cookie box.

28. The inductively heated vessel of claim 25 wherein the heating element includes a first plurality of conductive elements arranged in a first layer disposed on a first side of the product and a second plurality of conductive elements arranged in a second layer disposed on a second side of the product.

29. The inductively heated vessel of claim 28 wherein the heating element includes at least one conductive element arranged in a conductive loop, whereby loop currents are induced in the conductive loop when in the presence of the electromagnetic field.

30. The inductively heated vessel of claim 29 wherein at least a first portion of the conductive loop is in a first layer disposed on a first side of the product and a second portion of the conductive loop is in a second layer disposed on a second side of the product.

31. The inductively heated vessel of claim 30 wherein the plurality of first conductive elements define a first aperture and the plurality of second conductive elements includes at least one conductive element aligned with the first aperture.

32. The inductively heated vessel of claim 31 wherein the plurality of first conductive elements define a plurality of apertures and the plurality of second conductive elements includes a plurality of conductive elements aligned with the plurality of apertures.

33. The inductively heated vessel of claim 32 wherein the conductive elements are arranged in a non-uniform pattern with at least one aperture.

34. The inductively heated vessel of claim 33 wherein the conductive elements include a first conductive loop portion and a second conductive loop portion arranged in series.

35. The inductively heated vessel of claim 34 wherein the first conductive loop portion is disposed inside the second conductive loop.

36. The inductively heated vessel of claim 35 wherein the conductive element includes a first conductive loop portion disposed on a first side of the package and a second conductive loop portion disposed on a second side of the package.

37. The inductively heated vessel of claim 36 wherein at least one of the thickness and the width of the conductive element varies.

38. The inductively heated vessel of claim 37 wherein conductive elements are configured to induce eddy currents and loop currents.
